(19) United States
(12) Patent Application Publication
(10) Pub. No.: US 2005/0178772 A1
(43) Pub. Date: Aug. 18, 2005

(54) Liquid tank for use in a liquid-cooling type cooling apparatus

(75) Inventors: Jung Fong Huang, Sanchong City (TW); Chih Chien Huang, Sansia Township (TW)

Correspondence Address: BACON & THOMAS, PLLC, 625 SLATERS LANE, FOURTH FLOOR, ALEXANDRIA, VA, 22314, US

(73) Assignee: Forward Electronics Co., Ltd., Taipei City (TW)

(21) Appl. No.: 10/851,054

(22) Filed: May 24, 2004

(30) Foreign Application Priority Data
Feb. 16, 2004 (TW) 093202194

(51) Int. Cl. G05D 23/00

(52) U.S. Cl. 220/612

(57) ABSTRACT

A liquid tank for use in a liquid-cooling type cooling apparatus is disclosed having a tubular casing extruded from metal, and two cover plates drawn from the same metal and respectively press-fitted into the two open ends of the tubular casing and then fixedly joined thereto by welding.

### BACKGROUND OF THE INVENTION

1. Field of the Invention

The present invention relates to a liquid-cooling type cooling apparatus for use in a computer and more particularly, to a liquid tank for liquid-cooling type cooling apparatus.

2. Description of Related Art

In a computer, the main heat-generating electronic device is the CPU. In order to effectively dissipate heat from the CPU of a computer, a cooling apparatus shall be used.

FIG. 1 illustrates a conventional liquid-cooling type cooling apparatus for this purpose. This structure of liquid-cooling type cooling apparatus comprises a heat absorber 91, a liquid tank 92, and a heat sink 93. The heat absorber 91 is adapted to absorb heat from the CPU, for enabling absorbed heat energy to be transferred through liquid (such as pure water . . . ) inside a heat-transfer tube 94 to the heat sink 93. The liquid tank 92 is adapted to store a heat-transfer fluid.

Referring to FIGS. 1˜3, in order to prevent leakage and the occurrence of an internal pressure in the enclosed container upon heating of the fluid, the aforesaid liquid tank 92 is made of metal material. As illustrated, the liquid tank 92 comprises a top cover 921, and a bottom plate 922 welded to the bottom side of the top cover 921. The top cover 921 is made by way of a deepdrawing process repeatedly. However, the cost of a deepdrawing process is high. Further, because the top cover 921 has a certain depth, normally about 50 mm, it must be made by repeating a deepdrawing process more than three times. Therefore, the top cover 921 exhibits wrinkles in the outer appearance. After several deepdrawing procedures, the top cover 921 forms one single crystal direction, thereby loosing the tightness of crystal structure. After a long use of the liquid tank, the molecules of the liquid may escape out of the liquid tank, reducing the amount of the liquid. Further, the repeated deepdrawing process damages the internal crystal structure of the top cover, lowering the structural strength. Therefore, this structure of liquid tank is not satisfactory in function.

### SUMMARY OF THE INVENTION

The present invention has been accomplished under the circumstances in view. It is therefore the main object of the present invention to provide a liquid tank for use in a liquid-cooling type cooling apparatus, which has a high structural strength and low manufacturing cost. It is another object of the present invention to provide a liquid tank for use in a liquid-cooling type cooling apparatus, which prevents drying of the internal liquid, prolonging the service life.

To achieve these and other objects of the present invention, the liquid tank is comprised of a tubular casing and two cover plates. The tubular casing is extruded from metal, comprising an inside chamber and two openings in two distal ends thereof. The two cover plates made from metal and respectively fastened to the two openings of the tubular casing to hermetically seal the inside chamber. The two cover plates each have a through hole in communication between the inside chamber of the tubular casing and the outside. Because the tubular casing is extruded from metal, the manufacturing cost is low, and the crystal structure is maintained intact, prolonging the service life of the liquid tank.

The tubular casing can be extruded from copper or aluminum, having the shape of a rectangular tube. The two cover plates are drawn from the same metal material for the tubular casing.

Further, tubular casing comprises an inside face surrounding the inside chamber. The two cover plates each comprise a peripheral flange perpendicularly extended from the periphery and respectively press-fitted into the two openings of the tubular casing and closely attached and sealed to the inside face of the tubular casing. After insertion of the peripheral flanges of the two cover plates respectively into the two openings of the tubular casing, the two cover plates are fastened to the tubular casing by high-temperature welding.

### BRIEF DESCRIPTION OF THE DRAWINGS

FIG. 1 is an elevational view of a conventional liquid-cooling type cooling apparatus.

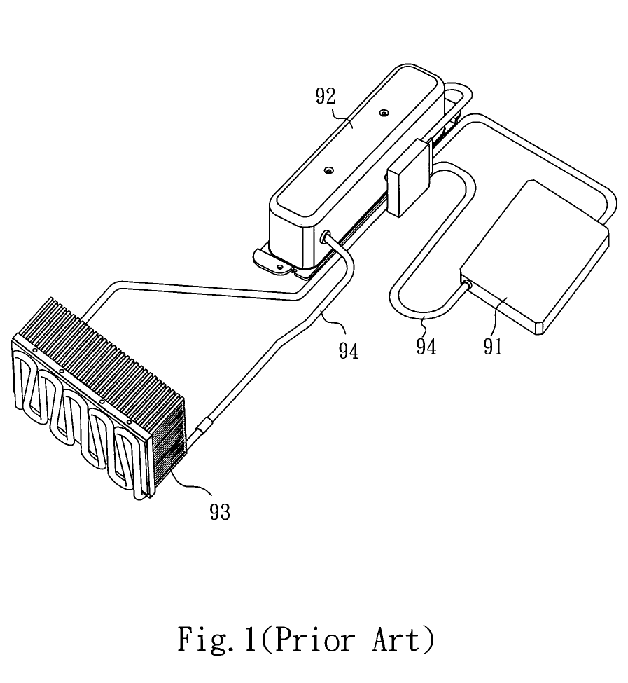

FIG. 2 is an exploded view of a liquid tank for use in a liquid-cooling type cooling apparatus according to the prior art.

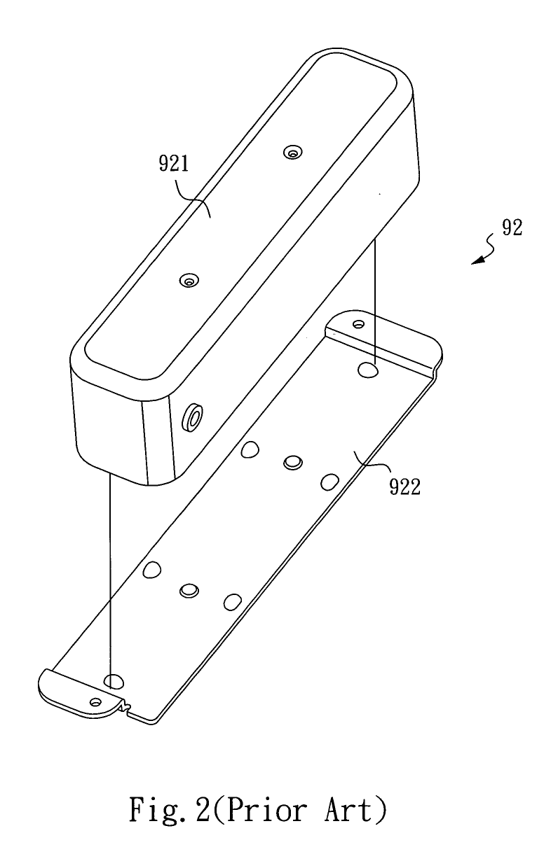

FIG. 3 is an elevational assembly view of the liquid tank according to the prior art.

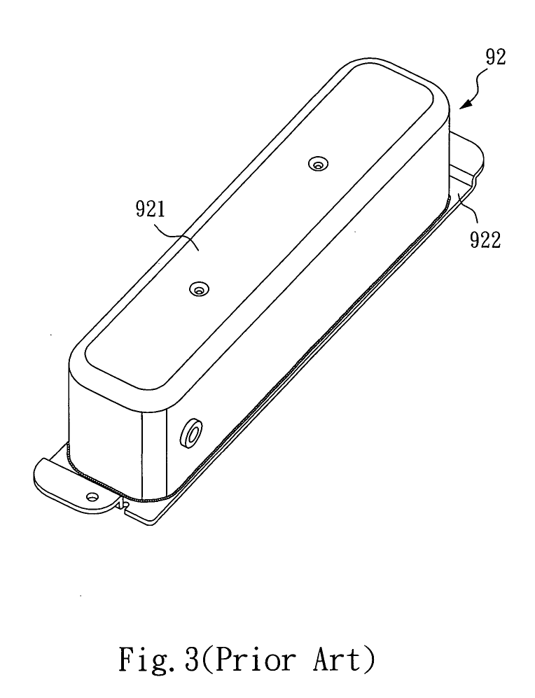

FIG. 4 is an exploded view of a liquid tank for use in a liquid-cooling type cooling apparatus according to the present invention.

FIG. 5 is a cutaway view showing the fabrication of the tubular casing for the liquid tank according to the present invention.

FIG. 6 is an elevational assembly view of the liquid tank according to the present invention.

### DETAILED DESCRIPTION OF THE PREFERRED EMBODIMENT

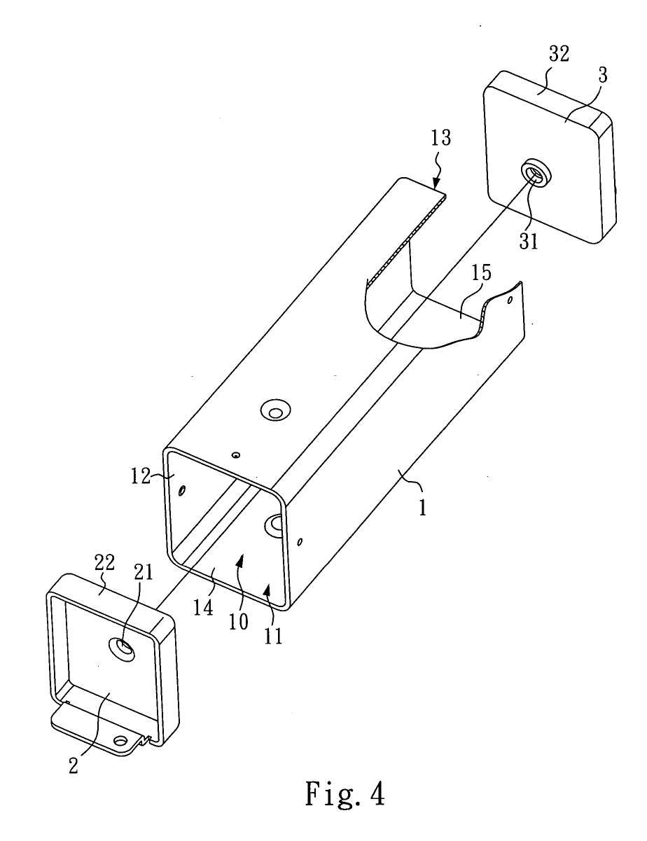

FIG. 4 is an exploded view of a liquid tank for use in a liquid-cooling type cooling apparatus according to the present invention. As illustrated, the liquid tank is comprised of a tubular casing 1, and two cover plates 2, 3.

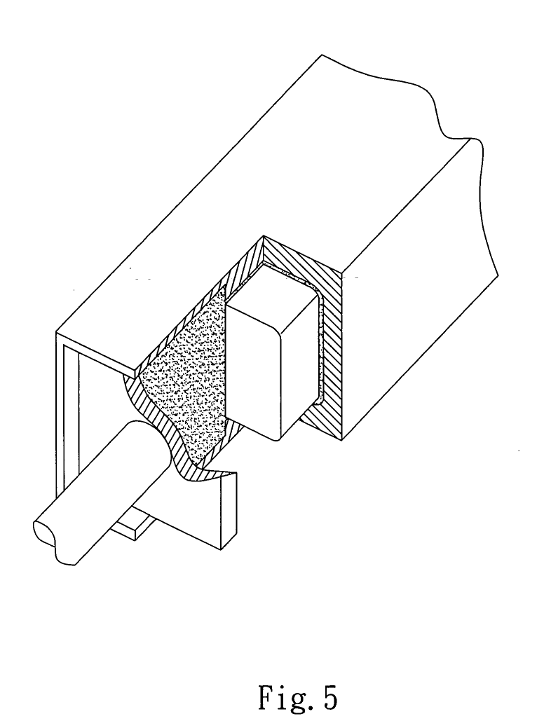

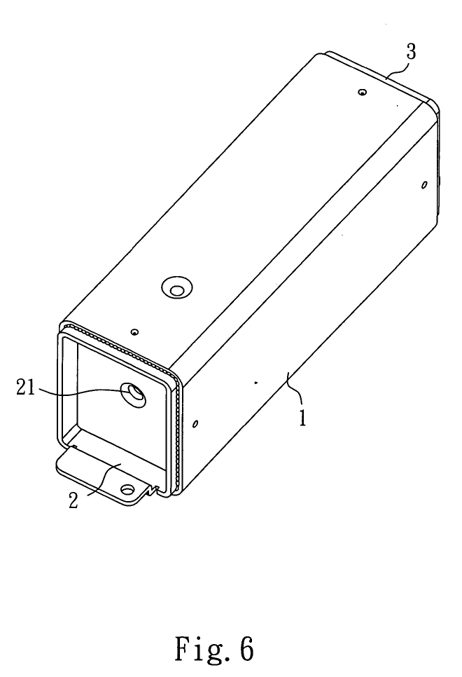

Referring to FIGS. 5 and 6 and FIG. 4 again, the tubular casing 1 is a rectangular tube extruded from metal, for example, copper (see FIG. 5). Aluminum or other suitable metal may be used to substitute for copper. The tubular casing 1 comprises an inside face 14 defining an open chamber 11, and two openings 12, 13 in the two distal ends.

The two cover plates 2, 3 are respectively drawn from metal, for example, copper. Alternatively, the two cover plates 2, 3 can be made of aluminum or other suitable metal. The two cover plates 2, 3 each have a peripheral flange 22, 32 perpendicularly extended from the periphery and respectively press-fitted into the two openings 12, 13 of the tubular casing 1 and closely attached and sealed to the inside face 14 of the tubular casing 1. After insertion of the peripheral flanges 22,32 of the two cover plates 2, 3 into the two openings 12, 13 of the tubular casing 1 respectively, the two cover plates 2, 3 are fixedly joined to the tubular casing 1 by high-temperature welding to hermetically seal the open chamber 11, thereby forming a watertight chamber 10. Thereafter, the two cover plates 2, 3 are processed to provide a respective center through hole 21, 31 in communication between the watertight chamber 10 and the outside space.

The two cover plates 2, 3 are welded to the tubular casing 1 with a phosphor-copper solder. Because the melting point of phosphor-copper is lower than copper, the molten phosphor-copper solder penetrates the gaps in between the peripheral flanges 22, 32 of the two cover plates 2, 3 and the inside face 14 of the tubular casing 1. When hardened, the phosphor-copper solder seals the gaps between the tubular casing 1 and the two cover plates 2, 3. After sealing, the tubular casing 1 and the two cover plates 2, 3 form a liquid tank for storing a heat-transfer liquid, for example, pure water.

Because the tubular casing 1 is directly extruded from metal, its manufacturing cost is low. Further, because the extrusion process does not damage the crystal structure of the tubular casing 1, the structural strength of the liquid tank is high, and the tubular casing 1 effectively prevents drying of the stored liquid and prolongs the service life of the liquid tank.

Although the present invention has been explained in relation to its preferred embodiment, it is to be understood that many other possible modifications and variations can be made without departing from the spirit and scope of the invention as hereinafter claimed.

1. A liquid tank for use in a liquid-cooling type cooling apparatus, the liquid tank comprising:
a tubular casing extruded from metal, said tubular casing comprising an inside chamber and two openings in two distal ends thereof; and
two cover plates made from metal and respectively fastened to the two openings of said tubular casing to hermetically seal said inside chamber, said two cover plates each having a through hole in communication between said inside chamber and theoutside.

2. The liquid tank as claimed in claim 1, wherein said two cover plates are respectively drawn from metal.

3. The liquid tank as claimed in claim 1, wherein said tubular casing comprises an inside face surrounding said inside chamber; said two cover plates each comprise a peripheral flange perpendicularly extended from the respective periphery thereof and respectively press-fitted into the two openings of said tubular casing and closely attached and sealed to the inside face of said tubular casing.

4. The liquid tank as claimed in claim 1, wherein said tubular casing is shaped like a rectangular tube.

5. The liquid tank as claimed in claim 1, wherein said two cover plates are respectively fastened to the two openings of said tubular casing by high-temperature welding.
